(19) United States
(12) Patent Application Publication
(10) Pub. No.: US 2004/0158735 A1
(43) Pub. Date: Aug. 12, 2004

(54) System and method for IEEE 802.1X user authentication in a network entry device

(75) Inventor: John J. Roese, Newmarket, NH (US)

Correspondence Address: CHRIS A. CASEIRO, VERRILL AND DANA, LLP, ONE PORTLAND SQUARE, PORTLAND, ME, 04112-0586, US

(73) Assignee: Enterasys Networks, Inc., Andover, MA (US)

(21) Appl. No.: 10/688,511

(22) Filed: Oct. 17, 2003

Related U.S. Application Data
(60) Provisional application No. 60/419,254, filed on Oct. 17, 2002.

(51) Int. Cl. H04L 9/00

(52) U.S. Cl. 713/200

(57) ABSTRACT

A system and method to authenticate attached functions seeking access to network services through a network entry device. The system includes a relay function of the network entry device for forwarding authentication messages to a device having full IEEE Standard 802.1X Port Access Entity (PAE) functionality. The relay function directs authentication information to the PAE device to perform the authentication function pursuant to that standard. The relay function eliminates the need for the network entry device to operate as a PAE device. The relay function may forward the authentication messages in a form compatible with IEEE Standard 802.1D or IEEE Standard 802.1Q.

### CROSS REFERENCE TO RELATED APPLICATION

This application claims the priority benefit of U.S. provisional patent application serial No. 60/419,254, filed Oct. 17, 2002, entitled “Relay Agent System For Full IEEE 802.1X User Authentication In An Edge Device,” of the same inventor and assigned to a common assignee. The contents of that provisional application are incorporated herein by reference.

### BACKGROUND OF THE INVENTION

1. Field of the Invention

The present invention relates to systems for regulating access to and usage of network services. More particularly, the present invention relates to the process of authenticating users of network services through the Institute of Electrical and Electronic Engineers (IEEE) Standard 802.1X entitled “Port-Based Network Access Control.” Still more particularly, the present invention relates to network infrastructure devices used to implement the 802.1X standard.

2. Description of the Prior Art

Computing systems are useful tools for the exchange of information among individuals. The information may include, but is not limited to, data, voice, graphics, and video. The exchange is established through interconnections linking the computing systems together in a way that permits the transfer of electronic signals that represent the information. The interconnections may be either cable or wireless. Cable connections include, for example, metal and optical fiber elements. Wireless connections include, for example infrared, acoustic, and radio wave transmissions.

Interconnected computing systems having some sort of commonality are represented as a network. For example, individuals associated with a college campus may each have a computing device. In addition, there may be shared printers and remotely located application servers sprinkled throughout the campus. There is commonality among the individuals in that they all are associated with the college in some way. The same can be said for individuals and their computing arrangements in other environments including, for example, healthcare facilities, manufacturing sites and Internet access users. A network permits communication or signal exchange among the various computing systems of the common group in some selectable way. The interconnection of those computing systems, as well as the devices that regulate and facilitate the exchange among the systems, represent a network. Further, networks may be interconnected together to establish internetworks. For purposes of the description of the present invention, the devices and functions that establish the interconnection represent the network infrastructure. The users, computing devices and the like that use that network infrastructure to communicate are referred to herein as attached functions and will be further defined. The combination of the attached functions and the network infrastructure will be referred to as a network system.

The process by which the various computing systems of a network or internetwork communicate is generally regulated by agreed-upon signal exchange standards and protocols embodied in network interface cards or circuitry and software, firmware and microcoded algorithms. Such standards and protocols were borne out of the need and desire to provide interoperability among the array of computing systems available from a plurality of suppliers. Two organizations that have been responsible for signal exchange standardization are the IEEE and the Internet Engineering Task Force (IETF). In particular, the IEEE standards for internetwork operability have been established, or are in the process of being established, under the purview of the IEEE 802 committee on Local Area Networks (LANs) and Metropolitan Area Networks (MANs).

The identified organizations generally focus on the mechanics of network and internetwork operation, less so on rules and restrictions on access to, and the provisioning of services associated with, the network. Presently, access to applications, files, databases, programs, and other capabilities associated with the entirety of a discrete network is restricted primarily based on the identity of the user and/or the network attached function. For the purpose of the description of the present invention, a “user” is a human being who interfaces via a computing device with the services associated with a network. For further purposes of clarity, a “network attached function” or an “attached function” may be a user connected to the network through a computing device and a network interface device, an attached device connected to the network, a function using the services of or providing services to the network, or an application associated with an attached device. Upon authentication of the offered attached function identity, that attached function may access network services at the level permitted for that identification. For purposes of the present description, “network services” include, but are not limited to, access, Quality of Service (QoS), bandwidth, priority, computer programs, applications, databases, files, and network and server control systems that attached functions may use or manipulate for the purpose of conducting the business of the enterprise employing the network as an enterprise asset. The basis upon which the network administrator grants particular permissions to particular attached functions in combination with the permissions is an established network usage policy.

As indicated above, access by an attached function to network services first requires authentication that the attached function is entitled to exchange communications with one or more devices of the network infrastructure. Typically, initial requests by attaching functions are transmitted to an authentication server or similar network infrastructure device having an authentication function. The authentication function may be embodied in a Network Operating System (NOS), a Remote Authentication Dial-In User Service (RADIUS) server, a Kerberos server, or other suitable authentication function device. Such authentication devices run algorithms designed to confirm that the function seeking network attachment has the appropriate credentials for attachment. The authentication function is managed by the network administrator.

Authentication is a valuable mechanism for minimizing harmful activity from adversely affecting the network system. However, they necessarily require the function seeking access to the network services to engage in exchanges with devices of the network infrastructure, including network entry devices. Sophisticated programmers with knowledge of network operations and signal exchange protocols have been able to compromise network systems through initial exchanges outside of the scope of the authentication process. In addition, the authentication process can slow the signal exchange process for an authorized attached function by tying up network infrastructure devices during the authentication. For these reasons, the IEEE developed the 802.1X standard, which provides for port-based network entry control based on a Media Access Control (MAC) identifier—Layer 2 of the Open Standards Interface (OSI) logical signal exchange hierarchy. The contents of the IEEE 802.1X standard are incorporated herein by reference.

In simple terms, the 802.1X standard provides a mechanism for restricting signal exchanges prior to authentication only to those signals required to establish authentication. There are three primary components of a network system with 802.1X functionality. They are: 1) the authentication server, 2) the authenticator, and 3) the supplicant. The authentication server operates as indicated above by matching attached function identification information with access entitlement information. The authenticator regulates signal exchanges between the attached function and the network infrastructure. The supplicant, such as an attached function as described herein, is the entity seeking access to the network services. The access request is initiated by the supplicant through a network access port of a network infrastructure device. The network access port may be a physical port or a logical port. An entity, such as a function module, incorporating the access control functionality associated with the 802.1X standard is referred to as a Port Access Entity (PAE). The port access entity may be associated with the authenticator, the supplicant, or a device or function that serves as an authenticator in some instances and as a supplicant in other instances.

In operation under the 802.1X standard, a network infrastructure device serving as an authenticator includes one or more sets of controlled and uncontrolled ports. The two ports are logical ports, with all signal exchanges between the authenticator and a supplicant occurring through a single network access port. Prior to authentication, all signal exchanges occur through the uncontrolled port. As a result, an attached function may exchange messages with the network infrastructure, but with limited access to network services. If the attached function is not 802.1X enabled and the network infrastructure device to which that attached function is so enabled, all communications will proceed through the uncontrolled port. In that condition, the attached function may be required to authenticate itself periodically throughout the network session and as a function of the network services it wishes to access. On the other hand, if the attached function is also 802.1X enabled, its preliminary exchanges with the network are restricted to the authentication process set out in the standard. Specifically, it is restricted to the uncontrolled port and only to exchange authentication messages pursuant to the Extensible Authentication Protocol (EAP). It is to be understood, however, that alternative forms of authentication may be implemented in the standard. The present invention is not limited to the particular authentication model. Upon authentication of the attached function/supplicant, the logical controlled port is enabled and the supplicant is granted access to those network services provisioned to that network access port for that authenticated supplicant. As a result, the attached function is not forced to re-authenticate unless as required under a proprietary network usage policy enforced by the network administrator.

The 802.1X standard provides enhanced network security and more efficient use of network services with reduced burden on the authentication server. However, it requires additional functionality embodied in any network infrastructure device designated as an authenticator. That functionality must compete with additional functionality capabilities of interest in network infrastructure devices. In particular, there is growing interest in producing network entry devices having relatively few functional features—enough to attach the attached functions without slowing throughput—at lower and lower prices. Therefore, there is an ongoing effort to balance better network access features with security and cost concerns, particularly in the network entry devices. Specifically, adding 802.1X PAE functionality to the Internet Protocol (IP) Layer 3 exchange protocol and the RADIUS authentication protocol functions now effectively required in any network entry device, significantly increases the price of what is preferably a relatively simple device. Additionally, embedded switching inside of IP phones has created an issue where the nature of the 802.1X protocol conflicts with the presence of an unintelligent Layer 2 device between an attached function and a central upstream network switching device with PAE functionality. Moreover, the wireless access point market is being led towards massive cost reduction that is fundamentally incompatible with the desire for higher function services, such as 802.1X PAE associated with an entry device.

Therefore, what is needed is a device and related method to establish 802.1X PAE functionality as part of a network infrastructure without burdening network entry devices of the infrastructure with such authentication functionality. Further, what is needed is such a device and related method to provide 802.1X PAE functionality throughout the network system for all attached functions seeking access to network services but without implementing that functionality in all network entry devices.

### SUMMARY OF THE INVENTION

The present invention is a device and related method to establish 802.1X PAE functionality as part of a network infrastructure without burdening network entry devices of the infrastructure with such authentication functionality. The device and related method provide the ability to establish 802.1X PAE functionality throughout the network system for all attached functions seeking access to network services but without implementing that functionality in all network entry devices. The device is a relay device or, more specifically, a relay function associated with the one or more network entry devices of the network infrastructure. The network entry devices including the relay function do not have full 802.1X PAE functionality. Instead, one or more central forwarding devices of the network infrastructure do have such full 802.1X PAE functionality, and the relay function forwards to such forwarding device the authentication messages required for attached function authentication. The network entry devices with the relay function include a logical uncontrolled port and a logical controlled port associated with the port interface. The uncontrolled port of the entry device only forwards authentication messages through the relay function to the 802.1X PAE. The controlled port of the entry device only forwards over the controlled port after the authenticator authenticates the attached function. The relay function of the invention eliminates the need for 802.1X PAE full functionality in network entry devices while maintaining full 802.1X authentication functionality. The relay function further has the ability to detect and implement the authentication messages and operations defined in IEEE 802.1X. That is, the relay function may continue to detect 802.1X messages even over a controlled port, such as when the PAE function triggers a request identification message to the attached function after original authentication has been completed. In that regard, the relay function monitors the port interface for such request identity messages.

In one aspect of the invention, a method is provided to authenticate an attached function for the purpose of permitting access by the attached function to the network services associated with a network system that includes a network entry device and an IEEE 802.1X PAE. The method includes the steps of receiving at the network entry device from the attached function one or more signal packets including authentication information, and forwarding the one or more signal packets including authentication information through a relay function the IEEE 802.1X PAE. The attached function may then be authenticated or not authenticated by an authentication server.

In another aspect of the invention, a system is provided to authenticate an attached function for the purpose of permitting access by the attached function to network services associated with a network infrastructure including a network entry device with a controlled port and an uncontrolled port, and an IEEE 802.1X Port Access Entity (PAE). The system includes a relay function of the network entry device and the PAE, the relay function configured to receive authentication signals from the attached function and forward the authentication signals to the PAE for authentication of the attached function before permitting access of the attached function to the network services through the network entry device.

In another aspect of the invention, there is an article of manufacture comprising a machine-readable medium that stores executable instruction signals that cause a machine to perform the method described above and related methods described herein.

The details of one or more examples related to the invention are set forth in the accompanying drawings and the description below. Other features, objects, and advantages of the invention will be apparent from the description and drawings, and from any appended claims.

### DESCRIPTION OF DRAWINGS

FIG. 1 is a simplified diagrammatic block representation of an example network system with the relay function of the present invention.

FIG. 2 is a simplified block representation of a network entry device including the relay function of the present invention.

FIG. 3 is a flow diagram illustrating primary steps of the relay function of the present invention.

### DETAILED DESCRIPTION OF PREFERRED EMBODIMENTS OF THE INVENTION

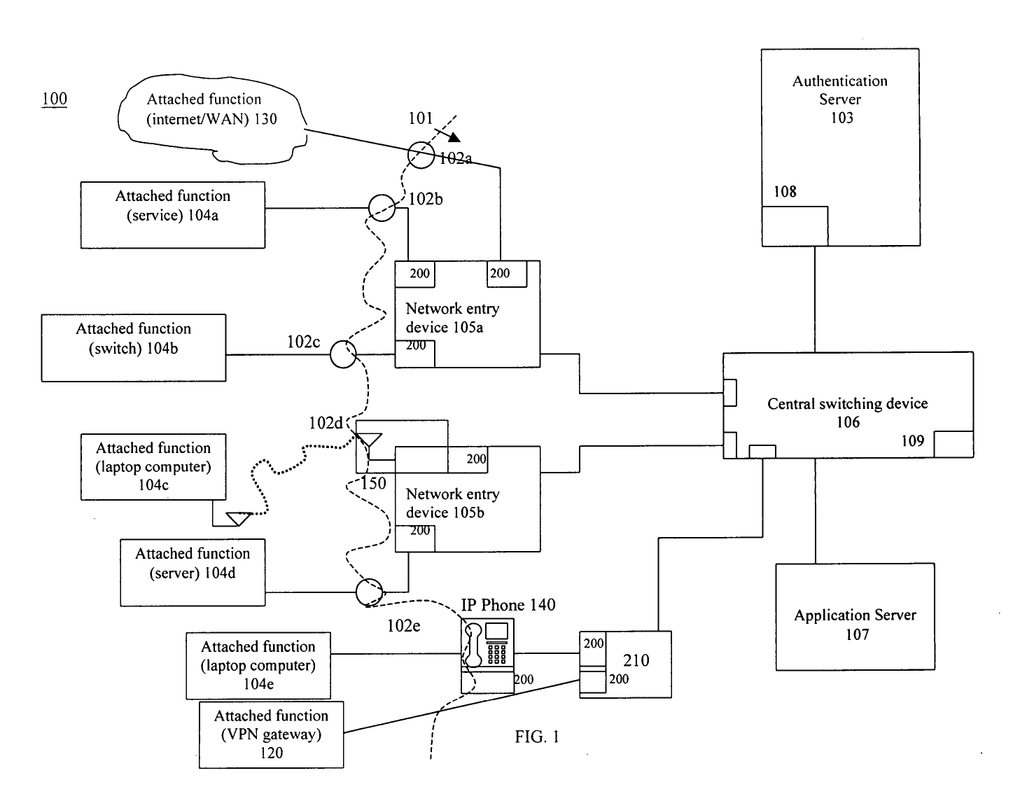

The present invention is a relay function and related method for establishing full 802.1X authentication functionality in a network system without implementing that full functionality in all network entry devices of the network infrastructure. Referring to FIG. 1, a network system 100 incorporating the 802.1X relay function of the present invention operates and provides network services to attached functions according to policies assigned to the attached functions. Those policies are assigned based upon the outcome of the authentication information associated with the attached function seeking network access. The network system 100 includes a network infrastructure 101 and one or more attached functions connected to or connectable to the network infrastructure 101. The network infrastructure 101 includes multiple switching devices, routing devices, access points, and other forms of network entry devices having forwarding functionality for the purpose of accessing and using network services. The attached functions may include Metropolitan Area Networks (MANs), Wide Area Networks (WANs), Virtual Private Networks (VPNs), and internet connectivity interconnected and connectable to the network infrastructure, all by way of connection points (e.g., 102a-d). One or more network entry devices of the network infrastructure include the authentication relay system function 200 of the present invention. That function may be implemented in one or more network entry devices of the network infrastructure 101 such as devices 105a, 105b, 140, 150, and 210. It is also contemplated that the relay function 200 may be embodied in one or more stand-alone devices connectable to the network entry devices.

The relay function 200 is embodied in hardware and software (e.g., a function embodied in an application executing on one or more network entry devices) to facilitate the authentication process throughout the entire network system 100. An attached function is external to infrastructure 101 and forms part of network system 100. Examples of attached functions 104a-104d are represented in FIG. 1, and may be any of the types of attached functions previously identified. Network infrastructure entry devices 105a-b of infrastructure 101 provide the means by which the attached functions connect or attach to the infrastructure 101. A network entry device can include and/or be associated with a wireless access point 150. For wireless connection of an attached function to the infrastructure 101, the wireless access point 150 can be an individual device external or internal to the network entry device 105b. For the purpose of illustrating the relay system of the present invention, the network entry devices 105a-b do not include any 802.1X functionality

One or more central forwarding devices, represented by central switching device 106, enable the interconnection of a plurality of network entry devices, such as devices 105a-b, as well as access to network services, such as authentication server 103 or an application server 107. It is to be understood that the forwarding device is not limited only to switches as that term is traditionally understood. Instead, the forwarding device may be any device capable of forwarding signals through the network infrastructure pursuant to forwarding protocols. The central switching device 106 enables the interconnection of the network infrastructure 101 to attached functions that include VPNs (represented by VPN gateway device 120) and WANs (represented by internet cloud 130) as well as Internet Protocol (IP) telephones (represented by telephone 140). It is to be understood that the IP telephone 140 may also perform as a network entry device for the purpose of connecting an attached function, such as a laptop computer, to the network infrastructure. For the purpose of describing the present invention, the central switching device includes full 802.1X PAE functionality. That is, it includes an interface with the authentication server 103 and the capability to restrict initial signal exchanges to those associated with authentication, e.g., EAP signals or signals associated with any other form of authentication model. It is to be understood that 802.1X PAE functionality may be embodied in one or more other network infrastructure devices. The network infrastructure may further include a tracking function for tracking the state of one or more sessions associated with one or more network entry devices.

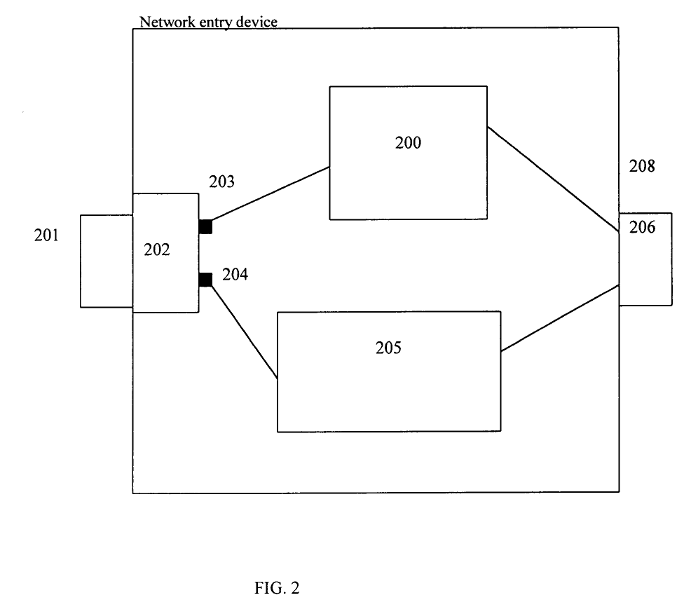

As illustrated in FIG. 2, a network entry device such as any of devices 105a, 105b, 210, and even 140 when operating an attached function connection point, includes the relay function 200. Each entry device includes an input port 201 for connecting to the attached function, either in a wired or a wireless form. The device is configured at a port interface 202 to recognize authentication signals received from the attached function, as well as signals that are not authentication signals but are intended for accessing the network infrastructure in some manner. Only authentication signals are forwarded from the port interface's uncontrolled input port 203 to the relay function 200. Any non-authenticated signals received at the port interface 202 prior to authentication are held at the port interface 202, or discarded. If the authentication process has been completed approving the attached function, non-authenticating signals are directed to the port interface's controlled input port 204 for forwarding to a packet forwarding function 205. It is to be understood that the forwarding function 205 may be any type of forwarding function including, but not limited to, an IEEE 802.1D protocol or an IEEE 802.1Q protocol. However, under the 802.1X standard, the port interface 202 does not forward non-authenticating signals to the uncontrolled input port 203.

With continuing reference to FIG. 2, the relay function 200 forwards authentication signals to the forwarding device, such as central switching device 106, through uncontrolled output port 206. Upon authentication, the forwarding function 205, forwards non-authenticating signals to the central switching device 206 through controlled output port 207. The network entry device is connected to the forwarding device at output port 208 associated with uncontrolled output port 206 and controlled output port 207. The relay function is preferably configured to implement a Layer 2 bridging function compatible with IEEE Standard 802.1D or IEEE Standard 802.1Q. The relay function is further configured to recognize the reserved MAC address and/or Ethertype of 802.1X packets received at port 203 and to direct such packets, unmodified, through port 206 to central switching device 106, as indicated. The central switching device 106, in turn, is connected to the authentication server 103 having an authentication module 108 with full authentication functionality. The central switching device includes full 802.1X PAE function, as represented by function 109 of FIG. 1. The central switching device 106 is also connected directly or indirectly to network services represented as application server 107.

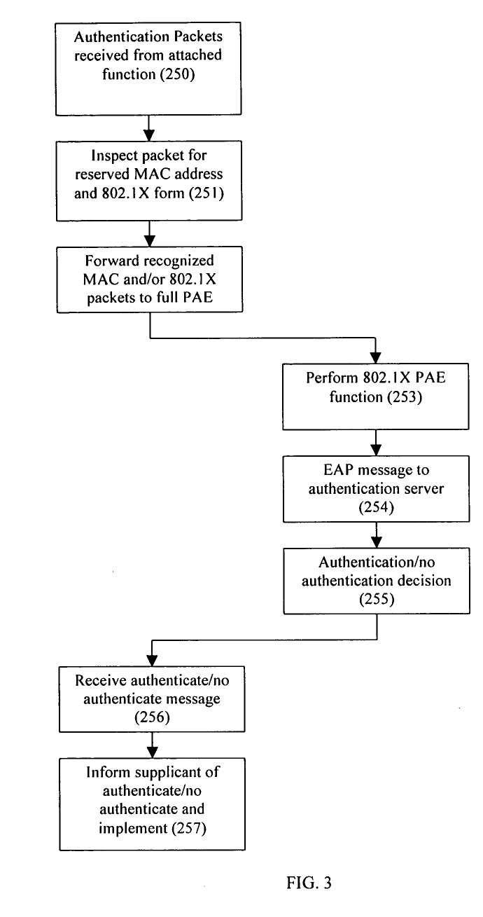

With reference to FIG. 3, in operation, the relay function 200 receives from uncontrolled input port 203 802.1X standard packets from an attached function (step 250). The relay function inspects the packets for reserved MAC addresses and 802.1X formats and compares them with stored known Ethernet and authentication packet types (step 251). Upon confirmation of known packet types for authentication purposes, the relay function directs the received packets to the central switching device 106 via the uncontrolled output port 206 (step 252). Unrecognized packets are discarded. At the central switching device 106, the packets transmitted by the relay device are examined for 802.1X EAP, or other authentication model, configuration by the PAE function module 109 (step 253). If the packets are confirmed authentication messages, they are transmitted to the authentication server 103 (step 254). The authentication server 103 compares the information included in the packets and renders an authenticated/not authenticated decision and generates an authentication message in conformance with the authentication model (step 255). The authentication message is received by the central switching device 106 and forwarded to the relay function through uncontrolled output port 207 (step 256). The authentication message is then transmitted to the attached function/supplicant and access to the network services is initiated or denied (step 257).

If the relay system of the present invention is implemented on multiple network entry devices of the network infrastructure, state must be kept on sessions relayed by either MAC address or internal 802.1X protocol indications. To that end, upon reception by such network entry devices of 802.1X packets from the forwarding device, that forwarding device preferably torwards such packets back to the appropriate network entry device port based on state information maintained. It is to be noted that the relay function may recognize EAP success messages and change port state at the port interface 202 to reflect the original 802.1X port state machine event established by the central switching device. This can include optionally for wireless access points the delivery of an initial Wired Equivalence Protocol key to the client. This can optionally be implemented without port state change, assuming the PAE function of the central switching device has the ability to control access point access based on full 802.1X processing. Further, the full 802.1X PAE functionality may be established in the central switching device based on the existing standard with no other changes except the ability to infer that the link to the relay device via the outbound port 220 is known and treated as a virtual shared link, with the ability to override the port state changes in the relay device, the network entry device, or both, as indicated in the 802.1X state machine of the module 109. The tracking of state as well as the changing of state may be implemented in a tracking function of any of the network infrastructure devices.

It is to be understood that the functions described herein may be implemented in hardware and/or software. For example, particular software, firmware, or microcode functions executing on the network infrastructure devices can provide the relay function. Alternatively, or in addition, hardware modules, such as programmable arrays, can be used in the devices to provide some or all of those capabilities. The arrangements of the present invention described herein enable implementation of 802.1X PAE functionality for low-end network entry devices without the cost associated with complete per network entry device implementation.

Other variations of the above examples may be implemented. One example variation is that the illustrated processes may include additional steps. Further, the order of the steps illustrated as part of the process is not limited to the order illustrated in FIG. 2, as the steps may be performed in other orders, and one or more steps may be performed in series or in parallel to one or more other steps, or parts thereof. For example, the determination of static and dynamic policies may be achieved in parallel.

Additionally, the processes, steps thereof and various examples and variations of these processes and steps, individually or in combination, may be implemented as a computer program product tangibly as computer-readable signals on a computer-readable medium, for example, a non-volatile recording medium, an integrated circuit memory element, or a combination thereof. Such computer program product may include computer-readable signals tangibly embodied on the computer-readable medium, where such signals define instructions, for example, as part of one or more programs that, as a result of being executed by a computer, instruct the computer to perform one or more processes or acts described herein, and/or various examples, variations and combinations thereof. Such instructions may be written in any of a plurality of programming languages, for example, Java, Visual Basic, C, or C++, Fortran, Pascal, Eiffel, Basic, COBOL, and the like, or any of a variety of combinations thereof. The computer-readable medium on which such instructions are stored may reside on one or more of the components of system 100 described above and may be distributed across one or more such components.

A number of examples to help illustrate the invention have been described. Nevertheless, it will be understood that various modifications may be made without departing from the spirit and scope of the invention. Accordingly, other embodiments are within the scope of the claims appended hereto.

What is claimed is:

1. A method of authenticating an attached function for the purpose of permitting access by the attached function to network services associated with a network infrastructure including a network entry device and an IEEE 802.1X Port Access Entity (PAE), the method comprising the steps of:
a. receiving at the network entry device from the attached function one or more signal packets including authentication information; and
b. transferring the one or more signal packets including authentication information through a relay function to the IEEE 802.1X PAE.

2. The method as claimed in claim 1 further comprising the step of making the transfer of the one or more signal packets through the relay function compatible with IEEE Standard 802.1D or IEEE Standard 802.1Q.

3. The method as claimed in claim 2 further comprising the step of examining the signal packets for a reserved Media Access Control address and/or an Ethernet type.

4. The method as claimed in claim 1 wherein the authentication information includes an Extensible Authentication Protocol message.

5. The method as claimed in claim 1 wherein the network infrastructure includes a plurality of network entry devices further comprising the step of maintaining state for one or more sessions associated with one or more network entry devices.

6. The method as claimed in claim 5 wherein the step of maintaining state is performed by a tracking function of one or more network infrastructure devices.

7. The method as claimed in claim 1 further comprising the steps of recognizing through a tracking function of the network infrastructure authentication success messages and enabling a change of state associated with a forwarding function of the network entry device.

8. The method as claimed in claim 7 wherein the tracking function forms part of the network entry device.

9. A system to authenticate an attached function for the purpose of permitting access by the attached function to network services associated with a network infrastructure, the network infrastructure including a network entry device having an uncontrolled input port, and a central forwarding device including an IEEE 802.1X Port Access Entity (PAE), the system comprising a relay function of the network entry device, the relay function configured to receive authentication signals from the uncontrolled input port of the network entry device and forward the authentication signals to the PAE for authentication of the attached function before permitting access of the attached function to the network services through the network entry device.

10. The system as claimed in claim 9 wherein the relay function forwards the authentication signals in a manner compatible with IEEE Standard 802.1D or IEEE Standard 802.1Q.

11. The system as claimed in claim 9 wherein the relay function is configured to recognize authentication signals for a reserved Media Access Control address and/or an Ethernet type.

12. The system as claimed in claim 9 wherein the network entry device further includes a forwarding function connected to a controlled input port of the network entry device, wherein the forwarding function is connected to the central forwarding device.

13. The system as claimed in claim 9 wherein the relay function is configured to recognize authentication information of the authentication signals received at the uncontrolled input port and to transfer the authentication signals to the PAE via an uncontrolled output port of the network entry device upon recognition of the authentication information.

14. The system as claimed in claim 9 further comprising a tracking function of the network infrastructure to authenticate success messages and to enable a change of state associated with a forwarding function of the network entry device.
